(19) United States
(12) Patent Application Publication
(10) Pub. No.: US 2003/0180698 A1
(43) Pub. Date: Sep. 25, 2003

(54) Mental disorder screening tool and method of screening subjects for mental disorders

(76) Inventor: Alen Salerian, Bethesda, MD (US)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/103,573

(22) Filed: Mar. 22, 2002

(51) Int. Cl. G09B 19/00

(52) U.S. Cl. 434/238; 434/236; 434/118

(57) ABSTRACT

A screening tool according to the present invention is utilized to evaluate a subject for the presence of a mental disorder. The subject is requested to rate various aspects or categories of their mood, preferably within the range from zero to ten. A total score is determined based on the responses and applied to a color coded chart having particular colors associated with various numeric ranges. The color associated with the numeric range encompassing the total score provides an indication and/or severity of the disorder. The tool may be utilized for various disorders (e.g., depression, attention deficit disorder, dementia, etc.), where the tool may include particular aspects, scales and/or questions corresponding to a particular disorder. The tool may be further utilized at periodic or other intervals to determine subject progress with respect to the disorder in response to medication, therapy and/or other treatment.

### BACKGROUND OF THE INVENTION

1. Technical Field

The present invention pertains to screening of subjects for the presence of mental, psychiatric or psychological disorders. In particular, the present invention pertains to a screening tool and method for rapidly determining the presence and/or severity of mental disorders within a subject by determining a screening score value and applying the value to a color coded chart to visually indicate the screening results.

2. Discussion of the Related Art

Depression is one of the more common psychological disorders. Estimates indicate that approximately one in every four women and one in every seven men will experience depression during their lifetime. The profoundly negative impact depression has on the social, economic and medical health aspects of the individual requires that depression be effectively diagnosed and treated.

Accordingly, the related art provides several psychiatric techniques to diagnose depression and other psychological disorders. For example, U.S. Pat. No. 5,882,203 (Correa et al) discloses a method of detecting depression and its severity. A series of statements (i.e., twenty) formulated to detect the presence and severity of depression are presented to the subject in a multiple item visual analog format. The answers are assigned a numerical value, while the total score is normatively ranked to determine the presence and severity of the depression.

U.S. Pat. No. 6,053,866 (McLeod) discloses a method of facilitating diagnosis of a psychiatric disorder in a patient including the steps of providing the patient with one or more questions relating to the symptoms of one or more psychiatric disorders in a format facilitating recordation of the answers and establishing a preliminary disorder indication based on the answers. The answer choices may be assigned values and relate to a frequency at which the patient suffers disorder symptoms. The values assigned to each answer are preferably numerical, where the sum of the numerical answer values is applied to a numerical range. If the sum is within the range, the sum is indicative of a particular preliminary disorder indication.

Additional techniques within the related art to diagnose depression and other mental disorders include: interviews, the Beck Depression Inventory (BDI) scale, the Hamilton (Seventeen) scale, the Montgomery-Asberg Depression Rating Scale (MADRS), the Zung Scale and the Mini-Mental Status Exam (MMSE).

In particular, interviews typically include lengthy structured discussions with the subject by a trained clinician. The clinician drives the discussion in particular directions in order to obtain certain information from the subject relating to a disorder. This technique is applicable to many disorders, including depression and attention deficit disorder.

The BDI and Zung scales each include a survey of numerous questions (e.g., twenty-one and twenty questions, respectively) to be completed by the subject. Each survey answer is associated with a value, typically in the range of zero to three for the BDI scale and one to four for the Zung scale. The sum of the answer values is applied to a numerical range to indicate the presence and/or severity of depression.

The Hamilton (Seventeen) scale includes seventeen items and provides ratings on symptoms of depression. The test is typically administered by a trained clinician using a semi-structured interview format. The items are rated on either a five point (i.e., zero to four) or three point (i.e., zero to two) range. The ratings are summed to produce a total score that is applied to a numeric range to provide an indication of depression.

The MADRS scale evaluates ten areas of depression symptoms and is typically administered by a trained clinician. Each area is rated on a seven point (i.e., zero to six) range. The ratings are summed to produce a total score that is applied to a numeric range to provide an indication of depression.

The MMSE test includes two sections. The first section requires vocal responses and evaluates orientation, memory and attention. The second section evaluates the ability to name, to follow verbal and written commands, to write a sentence spontaneously and to copy a complex polygon. The test score is applied to a numeric range to provide an indication of dementia.

The above-described techniques of the related art suffer from several disadvantages. In particular, the techniques tend to include numerous inquiries and require a substantial time interval to complete. For example, the Hamilton and MADRS techniques typically require a minimum of twenty minutes of clinician time to complete, while the BDI, Zung and MMSE techniques may endure on the order of ten minutes. Since approximately seventy percent of antidepressants are prescribed by primary care physicians who are under constant time pressure to diagnose and treat disorders (and generally spend less time with their patients than a typical psychologist, psychiatrist and/or psychiatric social worker), techniques having such durations are generally not practical and have limited use in clinical practice. Further, a portion of the techniques (e.g., MMSE) require the subject to read and/or write, thereby increasing the time interval to complete the test and to determine a score indicative of a mental disorder. In addition, the techniques do not provide a visual indication immediately conveying the screening results or disorder indication to the clinician.

Thus, there exists a need in the art for a reliable, patient-friendly and brief screening tool for a mental disorder that is practical for use in clinical and other settings.

### OBJECTS AND SUMMARY OF THE NVENTION

Accordingly, it is an object of the present invention to reliably screen a subject for a mental disorder in a brief time interval (e.g., within one minute).

It is another object of the present invention to screen a subject for a mental disorder and provide a visual color indication that readily conveys the presence and/or severity of the disorder within the subject.

Yet another object of the present invention is to screen a subject having a mental disorder subsequent medication and/or therapy to determine subject progression in response to treatment.

The aforesaid objects may be achieved individually and/or in combination, and it is not intended that the present invention be construed as requiring two or more of the objects to be combined unless expressly required by the claims attached hereto.

According to the present invention, a screening tool is utilized to evaluate a subject for the presence of a mental disorder. The subject is requested to rate various aspects or categories of their mood, preferably within the range from zero to ten. For example, with respect to depression, the aspects include mood, motivation, energy level, frustration tolerance and ability to enjoy life. A total score is determined based on the responses and applied to a color coded chart having particular colors associated with various numeric ranges. The color associated with the numeric range encompassing the total score provides an indication and/or severity of the disorder. The tool may be utilized for various disorders (e.g., depression, attention deficit disorder, dementia, etc.), where the tool may include particular aspects, scales and/or questions corresponding to a particular disorder. The responses may be supplied by the subject and/or clinician and are utilized to produce a total score, while the color chart indicates the presence and/or severity of the particular disorder based on the total score as described above. The tool may be further utilized at periodic or other intervals to determine subject progress with respect to the disorder in response to medication, therapy and/or other treatment.

The present invention screening tool provides several advantages. In particular, the screening tool includes a few questions and requires a short time interval, typically on the order of four or five questions that may be completed within twenty seconds (e.g., whereas the above-described techniques of the related art include several questions and require on the order often to twenty minutes). The tool provides the patient and clinician a comprehendible and visible measure of the patient mood (e.g., the total score and color chart indicate the presence and/or severity of the disorder). The aspects are arranged within a color scheme that enables the clinician to easily render decisions with respect to a particular pharmacological course of action. Further, the tool may be utilized to determine clinical response, while the combination of the total score and color indication assist the patient and clinician in measuring patient progress. In addition, the depression tool screens for suicidal tendencies within the patient (e.g., as part of the aspects) without openly confronting the patient about this issue.

The above and further objects, features and advantages of the present invention will become apparent upon consideration of the following detailed description of specific embodiments thereof, particularly when taken in conjunction with the accompanying drawings, wherein like reference numerals in the various figures are utilized to designate like components.

### BRIEF DESCRIPTION OF THE DRAWINGS

FIG. 1 is a schematic illustration of a tool for screening a subject for depression according to the present invention.

FIG. 2 is a procedural flow chart illustrating the manner in which the tool is utilized to screen a subject for a mental disorder according to the present invention.

FIG. 3 is a schematic illustration of a tool for screening a subject for attention deficit disorder according to the present invention.

FIG. 4 is a schematic illustration of a tool for screening a subject for dementia according to the present invention.

### DETAILED DESCRIPTION OF THE PREFERRED EMBODIMENTS

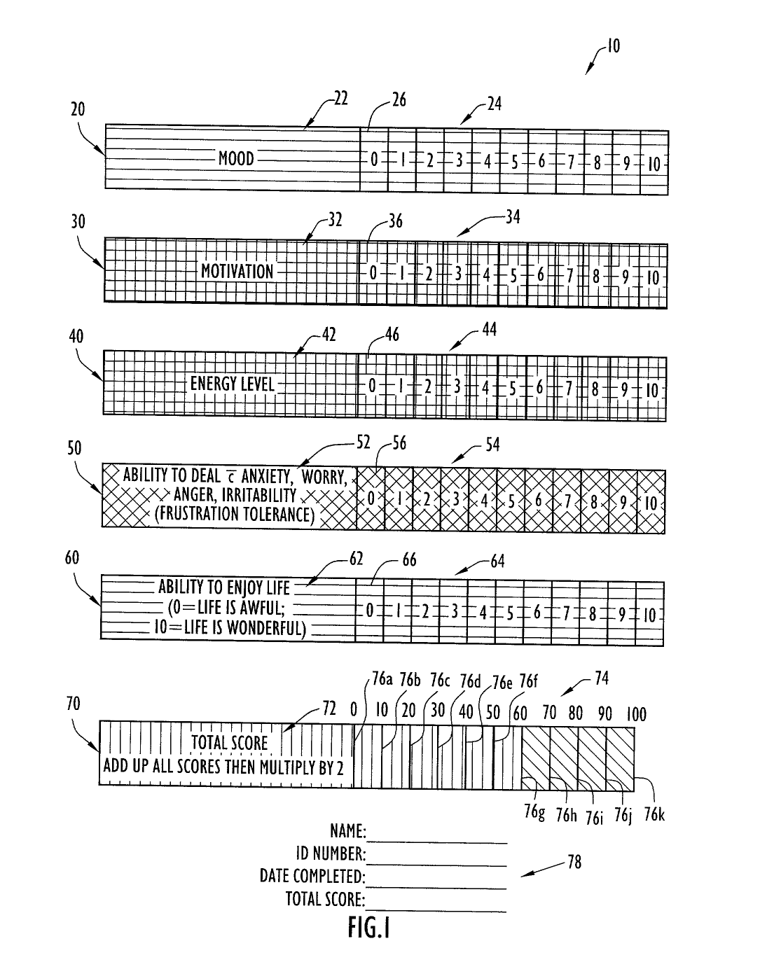

A tool for diagnosing and screening a subject or patient for depression is illustrated in FIG. 1. Specifically, tool 10 includes a plurality of aspect fields 20, 30, 40, 50, 60, each including a particular color and associated with a patient characteristic or aspect relating to a symptom of depression, and a score field 70 providing results of the screening. The aspect field colors tend to identify the individual characteristics and enable the clinician to easily identify problematic areas and determine a pharmacological approach as described below. The aspect and score fields are vertically spaced and extend horizontally substantially parallel to each other. Field 20 is typically blue and associated with the mood of the patient. Field 20 includes a corresponding text section 22 indicating the characteristic title (e.g., mood) and a rating scale 24 with a series of cells 26 each associated with a numeral from zero to ten. The cells extend in a horizontal direction with a leftmost cell 26 (e.g., as viewed in FIG. 1) being associated with the numeral zero and each successive cell thereafter being associated with a consecutive numeral in the range from one to ten. The numerals provide an indication of the patient mood, where zero represents a bad mood and ten represents a good mood.

Field 30 is typically yellow and disposed below field 20. Field 30 is associated with patient motivation or initiative to perform activities and includes a corresponding text section 32 indicating the characteristic title (e.g., motivation) and a rating scale 34 with a series of cells 36 each associated with a numeral from zero to ten. The cells extend in a horizontal direction with a leftmost cell 36 (e.g., as viewed in FIG. 1) being associated with the numeral zero and each successive cell thereafter being associated with a consecutive numeral in the range from one to ten. The numerals provide an indication of the patient motivation, where zero represents no motivation and ten represents abundant motivation. Field 40 is typically yellow and disposed below field 30. Field 40 is associated with a patient energy level and includes a corresponding text section 42 indicating the characteristic title (e.g., energy level) and a rating scale 44 with a series of cells 46 each associated with a numeral from zero to ten. The cells extend in a horizontal direction with a leftmost cell 46 (e.g., as viewed in FIG. 1) being associated with the numeral zero and each successive cell thereafter being associated with a consecutive numeral in the range from one to ten. The numerals provide an indication of the patient energy level, where zero represents fatigue or tiredness and ten represents an energetic individual.

Field 50 is typically orange and disposed below field 40. Field 50 is associated with the frustration tolerance of the patient or, in other words, the ability to deal with anxiety, worry, anger and irritability. The field includes a corresponding text section 52 indicating the characteristic title (e.g, frustration tolerance) and a rating scale 54 with a series of cells 56 each associated with a numeral from zero to ten. The cells extend in a horizontal direction with a leftmost cell 56 (e.g., as viewed in FIG. 1) being associated with the numeral zero and each successive cell thereafter being associated with a consecutive numeral in the range from one to ten. The numerals provide an indication of the patient frustration tolerance where, zero represents little or no tolerance for frustration (e.g., inability to deal with anxiety, worry, anger and irritability) and ten represents a high tolerance for frustration (e.g., able to handle anxiety, worry, anger and irritability).

Field 60 is typically blue and disposed below field 50. Field 60 is associated with the ability to enjoy life and includes a text section 62 indicating the characteristic title (e.g., ability to enjoy life) and a rating scale 64 with a series of cells 66 each associated with a numeral from zero to ten. The cells extend in a horizontal direction with a leftmost cell 66 (e.g., as viewed in FIG. 1) being associated with the numeral zero and each successive cell thereafter being associated with a consecutive numeral in the range from one to ten. The numerals provide an indication of the patient ability to enjoy life, where zero represents the patient perception that life is awful and ten represents the patient perception that life is wonderful. This field further serves as a suicide indicator as described below.

Score field 70 is disposed below field 60 and includes a text section 72 indicating the field title (e.g., total score) and a color numeric range scale 74 including the colors of red and green. Field 70 basically serves as a color chart to indicate the presence and/or severity of depression within the patient as described below. Range scale 74 includes a series of dividers 76a-k each associated with an incremental numeric value within the tool score range of zero to one-hundred and horizontally spaced at substantially equal distances from each other. By way of example only, the numeric values associated with the dividers are in increments often (e.g., 0, 10, 20, 30, 40, 50, 60, 70, 80, 90 and 100). The range scale includes different colors, where the area between dividers 76a and 76g (e.g., representing the range from zero to sixty) is red and between dividers 193g and 193k (e.g., representing the range from sixty to one-hundred) is green. The total score is determined by doubling the sum of ratings provided by the subject for the above-described aspects. The ratings are recorded within and obtained from rating scales 24, 34, 44, 54 and 64 as described below. The total score is subsequently applied to field 70 to indicate the presence and/or severity of depression. In particular, the color of the range scale area corresponding to the total score (e.g., the area including a divider associated with a value equal to the total score or including successive dividers with associated values forming a range within which the total score lies) provides the patient and/or clinician with a comprehendible and visible measure of the degree of depression. Basically, the red area or a total score between zero and sixty indicates the presence of depression, while the green area or a total score between sixty and one-hundred indicates the absence of depression. Thus, the lower the total score, the greater the severity of the disorder.

Field 78 is disposed below field 70 and includes various text sections for receiving information concerning the patient and screening. This information may include the patient name, identification number, date and total score. The information is typically placed in the field by the clinician during screening of the patient.

The tool basically probes the patient in the specific areas of mood, motivation, energy level, frustration tolerance and ability to enjoy life as described above. These areas have been selected for the tool based on clinical research suggesting that those areas are reliable indicators of a depressive disorder with the ability to enjoy life being a crucial aspect in diagnosing depression. In other words, the research suggests that a majority of patients with symptoms consistent with the diagnosis of Dysthymic Disorder or depression present changes in the tool aspects. Therefore, measuring these areas provides an adequate screening of a possible depressive disorder.

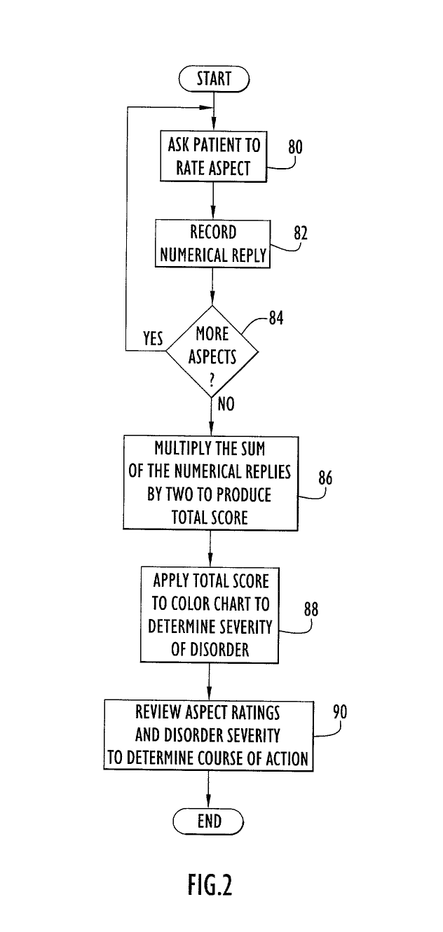

The manner in which the tool is utilized to screen a patient for a mental disorder is illustrated in FIG. 2. Initially, a clinician enters patient and other information in field 78 of tool 10 (FIG. 1). This information may include the patient name, identification number and date. Specifically, the clinician requests the patient at step 80 to rate an aspect of the patient mood over the preceding week or other time interval in a range from zero to ten, where zero represents the worst mood and ten represents the best mood. The patient responds with their perception of the aspect and the clinician records the response in the appropriate rating scale field at step 82. This may be accomplished by placing an identifier within or external of the appropriate rating scale cell associated with the numeral corresponding to the patient response (e.g., placing an ‘x’ in the cell, placing a circle around the cell, placing an arrow indicating the cell, etc.). If additional aspects remain as determined at step 84, the clinician proceeds to request ratings for the additional aspects as described above. Basically, the clinician requests the patient to rate each of the aspects indicated within tool fields 20 (mood), 30 (motivation), 40 (energy level), 50 (frustration tolerance) and 60 (ability to enjoy life), and records the response in corresponding rating scale fields 24, 34, 44, 54 and 64 as described above.

When the patient has rated each aspect as determined at step 84, the clinician sums each aspect rating and doubles that sum (e.g., multiplies the sum by two) to produce a total score at step 86. The total score is applied to field 70 to determine the presence and/or severity of the disorder at step 88. In particular, the clinician identifies the range scale area corresponding to the total score based on divider values. The color corresponding to the identified area provides a visual indication of the presence and/or severity of the disorder. Specifically, the red area indicates the presence of the disorder, while a green area indicates absence of that disorder. By way of example only, field 70 includes a numeric range of zero to one-hundred. Total scores having values below sixty indicate depression and the corresponding range scale area including dividers with associated values in this range is red. Total scores having values in excess of sixty indicate a lack of depression and the corresponding range scale area including dividers associated with numerals in that range is green. Total scores having values near sixty indicate a possibility or suspicion of depression and further evaluation maybe required. Thus, the particular color provides a visual indication of and immediately conveys the presence and/or severity of the disorder to the clinician and/or patient.

The screening requires a short time interval to provide results, typically on the order of twenty seconds. Once the clinician determines the severity of the disorder, the ratings for the aspects may be reviewed at step 90 to determine a course of action. The field colors associated with the aspects enable a clinician to immediately identify problematic areas and determine a suitable pharmacological approach. In particular, low ratings in energy and motivation (e.g., low ratings in the yellow fields) may require elevating patient levels of dopamine and norepinephrine (i.e., particular brain neurotransmitters), while a low frustration tolerance (e.g., a low rating in the orange field) may require treatment by elevating patient serotonin (i.e., a particular brain neurotransmitter). For example, a patient taking a serotonergic agent and providing a low rating for energy and motivation may be a suitable candidate for medication that increases dopamine and norepinephrine to increase the ratings for these characteristics. Similarly, a patient being treated with an antidepressant and providing a low rating for frustration tolerance may be a suitable candidate for elevation of brain serotonin levels via a serotonergic agent. Thus, the color scheme enables the clinician to immediately identify problematic areas or the particular aspects receiving a low rating.

The tool further serves to identify suicidal tendencies in a patient without openly confronting this issue with the patient. Physicians and clinicians are apprehensive concerning directly asking patients whether or not the patient has suicidal tendencies. A common concern is offending the patient and implanting suicidal thoughts into the patient's mind. However, not screening patients with depression for suicidality is medically unjustified. Accordingly, the tool determines a patient suicidal risk without including a question directly pertaining to suicide. This is accomplished by the aspect relating to the ability to enjoy life. The patient rating with respect to this aspect basically provides an indication of the potential suicide risk. For example, when the patient rating for this aspect is between zero and three (e.g., life is awful), this indicates that the patient is a suicide risk and further exploration is required, preferably in the form of asking specific questions. Thus, the tool is a less threatening and clinician-friendly instrument, particularly suited for primary care physicians whose time is severely limited for exploration of complicated areas of mental status, such as suicidality.

The depression tool of the present invention was tested with respect to the well-established and validated Montgomery-Asberg Depression Rating Scale (MADRS). The present invention tool and MADRS were administered concurrently to a sample population (e.g., psychiatric outpatients between the ages of seventeen and seventy-six including forty-three males, fifty-seven females and six outpatients not specifying a gender). The results indicated that the total scores in each technique are highly correlated for males, females and the sample population (e.g., −0.9341 correlation for males; −0.944245 correlation for females; and −0.929307 correlation for the sample population). The negative correlation indicates that the low total scores attained from the present invention tool (where low total scores indicate the presence of depression) are highly correlated to the high total scores attained from MADRS (e.g., where high total scores from MADRS indicate the presence of depression). Thus, the present invention tool provides a rapid and valid depression screening mechanism.

The tool may be further utilized to determine clinical response (e.g., patient response to treatment). In particular, the tool may be administered in substantially the same manner described above at particular periodic or other intervals or at a certain time interval after treatment. The various ratings provided by the patient should change in response to progression or regression. The total score and corresponding color change accordingly-based on the newly provided ratings. A decrease in total score and/or a color transition from green to red indicate patient regression, while an elevated total score and/or a color transition from red to green indicate patient progression. Thus, the combination of color and a concrete number assist the clinician and/or patient to measure progress. Further, the clinician may review the various aspect ratings to identify problematic areas and determine a suitable pharmacological approach as described above. The tool basically provides a quick initial indication of the presence and/or severity of a mental disorder and enables the clinician to recommend further evaluation and/or treatment.

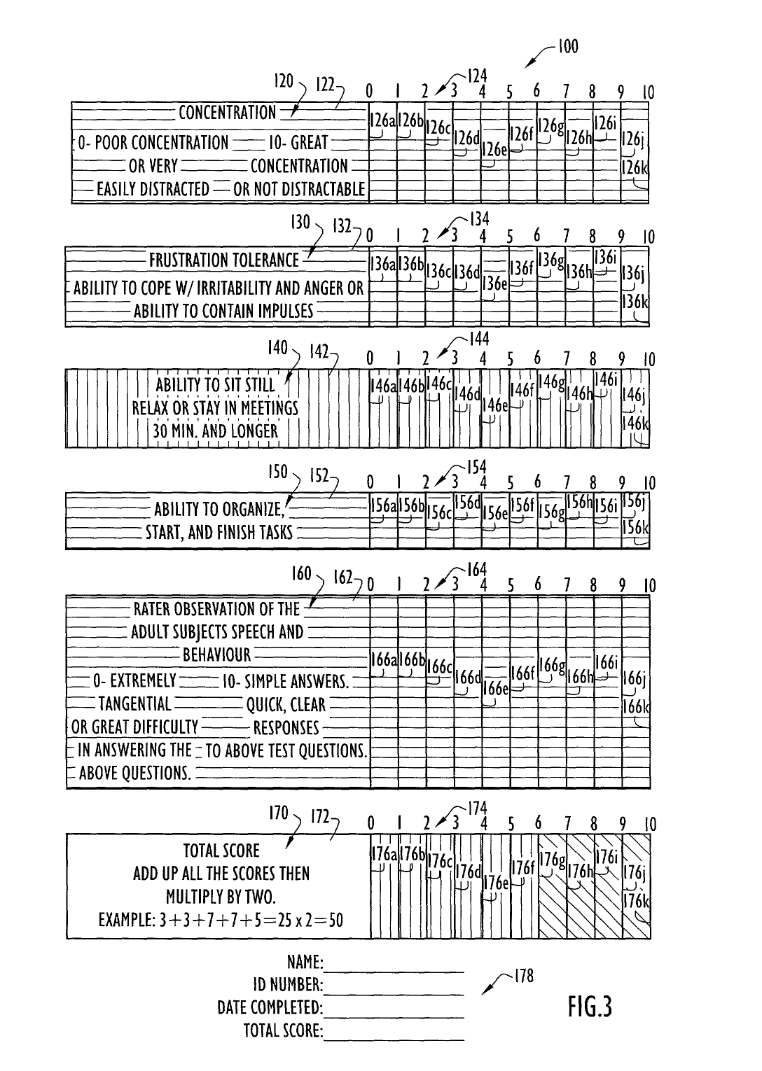

The tool has application for screening patients for various disorders. An exemplary tool to screen patients for attention deficit disorder is illustrated in FIG. 3. Initially, tool 100 is similar to and functions in a similar manner as tool 10 described above, except that the particular aspects for patient rating are directed toward attention deficit disorder and a clinician provides a rating based on patient behavior. Specifically, tool 100 includes a plurality of aspect fields 120, 130, 140, 150 and 160, each including a particular color and associated with a patient characteristic or aspect relating to a symptom of attention deficit disorder, and a score field 170 providing results of the screening. The aspect field colors tend to identify the individual characteristics and enable the clinician to easily identify problematic areas and determine psychological and/or biological approaches as described below. The aspect and score fields are vertically spaced and extend horizontally substantially parallel to each other. Field 120 is typically blue and associated with the ability of the patient to concentrate. The field includes a corresponding text section 122 indicating the characteristic title (e.g., concentration) and a rating scale 124 with a series of dividers 126a-k each associated with a successive numeric value within the range of zero to ten (e.g., 0, 1, 2, 3, 4, 5, 6, 7, 8, 9 and 10) and horizontally spaced at substantially equal distances from each other.

The numerals provide an indication of the patient characteristic concentration, where zero represents poor concentration or easily distracted and ten represents great concentration or not easily distracted.

Field 130 is typically blue and disposed below field 120. Field 130 is associated with the frustration tolerance of the patient or, in other words, the ability to deal with irritability and anger or to contain impulses. The field includes a corresponding text section 132 indicating the characteristic title, (e.g., frustration tolerance) and a rating scale 134 with a series of dividers 136a-k each associated with a successive numeric value within the range of zero to ten (e.g., 0, 1, 2, 3, 4, 5, 6, 7, 8, 9 and 10) and horizontally spaced at substantially equal distances from each other. The numerals provide an indication of the patient frustration tolerance, where zero represents little or no frustration tolerance (e.g., inability to deal with irritability and anger or to contain impulses) and ten represents a high frustration tolerance (e.g., able to handle irritability and anger or to contain impulses).

Field 140 is typically red and disposed below field 130. Field 140 is associated with a patient ability to sit still, relax or stay in meetings (e.g., thirty minutes and longer) and includes a corresponding text section 142 indicating the characteristic title (e.g., ability to sit still, relax or stay in meetings) and a rating scale 144 with a series of dividers 146a-k each associated with a successive numeric value within the range of zero to ten (e.g., 0, 1, 2, 3, 4, 5, 6, 7, 8, 9 and 10) and horizontally spaced at substantially equal distances from each other. The numerals provide an indication of the patient ability to sit still, where zero represents an inability to sit still or fidgety and ten represents the ability to sit still.

Field 150 is typically blue and disposed below field 140. Field 150 is associated with the ability to organize, start and finish tasks and includes a corresponding text section 152 indicating the characteristic title (e.g., ability to organize, start and finish tasks), and a rating scale 154 with a series of dividers 156a-k each associated with a successive numeric value within the range of zero to ten (e.g., 0, 1, 2, 3, 4, 5, 6, 7, 8, 9 and 10) and horizontally spaced at substantially equal distances from each other. The numerals provide an indication of the patient ability to organize, start and finish tasks, where zero represents the inability to organize and complete tasks and ten represents the ability to perform these functions. Field 160 is typically blue and is disposed below field 150. Field 160 is associated with the clinician observation of the subject speech and behavior during the screening. The field includes a corresponding text section 162 indicating the characteristic title (e.g., rater observation of the adult subjects speech and behavior) and a rating scale 164 with a series of dividers 166a-k each associated with a successive numeric value within the range of zero to ten (e.g., 0, 1, 2, 3, 4, 5, 6, 7, 8, 9 and 10) and horizontally spaced at substantially equal distances from each other. The numerals provide an indication of the patient speech and behavior, where zero represents the patient being extremely tangential or having great difficulty in answering the tool questions and ten represents the patient ability to provide simple answers or quick and clear responses to the tool questions.

Score field 170 is disposed below field 160 and includes a corresponding text section 172 indicating the field title (e.g., total score) and a color numeric range scale 174 including the colors of red and green. Field 170 basically serves as a color chart to indicate the presence and/or severity of the disorder within the patient as described below. Range scale 174 includes a series of dividers 176a-k each associated with an incremental numeric value within the tool score range of zero to one-hundred. By way of example only, the numeric values associated with the dividers are in increments of ten (e.g., 0, 10, 20, 30, 40, 50, 60, 70, 80, 90 and 100). The range scale includes different colors where the area between dividers 176a and 176g (representing the range from zero to sixty) is red and between dividers 176g and 176k (representing the range from sixty to one-hundred) is green. The total score is determined by doubling the sum of ratings provided by the subject and clinician for the above-described aspects. The ratings are recorded within and obtained from rating scales 124, 134, 144, 154 and 164 as described below. The total score is subsequently applied to field 170 to indicate the presence and/or severity of attention deficit disorder. In particular, the color of the range scale area corresponding to the total score (e.g., the area including a divider associated with a value equal to the total score or including successive dividers with associated values forming a range within which the total score lies) provides the patient and/or clinician with a comprehendible and visible measure of the degree of attention deficit disorder. Basically, the red area or a total score between zero and sixty indicates the presence of attention deficit disorder, while the green area or a total score between sixty and one-hundred indicates the absence of that disorder. Thus, the lower the total score, the greater the severity of the disorder.

Field 178 is disposed below field 170 and includes various text sections for receiving information concerning the patient and screening. This information may include the patient name, identification number, date and total score. The information is typically placed in the field by the clinician during screening of the patient.

The tool basically probes the patient in the specific areas of concentration, frustration tolerance, ability to sit still and ability to organize, start and finish tasks, while the clinician rates the patient behavior during the screening as described above. These areas have been selected for the tool based on clinical research suggesting that those areas are reliable indicators of the disorder. Therefore, measuring these areas provides an adequate screening of a possible attention deficit disorder.

The manner in which tool 100 is utilized to screen a patient for attention deficit disorder is described. Basically, the manner of utilization of tool 100 is substantially similar to the manner of utilization for tool 10 described above for FIG. 2, except that the clinician provides the rating for the patient behavioral aspect. Initially, a clinician enters patient and other information in field 178 of tool 100 (FIG. 3). This information may include the patient name, identification number and date. Specifically, the clinician requests the patient to rate aspects of the patient average mental functioning over the preceding week or other time interval in a range from zero to ten with zero representing the worst or poor functioning and ten representing the best or exceptional functioning. The patient responds with their perception of the aspect and the clinician records the response in the appropriate rating scale field. This may be accomplished by placing an identifier proximate the appropriate divider and/or associated numeral corresponding to the patient response (e.g., placing a circle around the divider and/or numeral, placing an arrow indicating the divider and/or numeral, etc.). In other words, the clinician basically requests the patient to rate each of the aspects indicated within tool fields 120 (concentration), 130 (frustration tolerance), 140 (ability to sit still) and 150 (ability to organize start and finish tasks) and records the response in corresponding rating scale fields 124, 134, 144, and 154 as described above.

When the patient has rated each aspect, the clinician rates the patient behavior and records the rating in corresponding rating scale field 164. The clinician subsequently sums each aspect rating and doubles the sum (e.g., multiplies by two) to produce a total score. The total score is applied to field 170 to determine the presence and/or severity of the disorder as described above. In particular, the clinician identifies the range scale area corresponding to the total score based on divider values. The color corresponding to the identified area provides a visual indication of the presence and/or severity of the disorder. Specifically, the red area indicates the presence of the disorder, while the green area indicates the absence of that disorder. By way of example only, field 170 includes a numeric range of zero to one-hundred. Total scores having values below sixty indicate attention deficit disorder and the corresponding range scale area including dividers associated with numerals in this range is red. Total scores having values in excess of sixty indicate a lack of the disorder and the corresponding range scale area including dividers associated with numerals in that range is green. Total scores having values near sixty indicate a possibility or suspicion of attention deficit disorder and further evaluation may be required. Thus, the particular color provides a visual indication of and immediately conveys the presence and/or severity of the disorder to the clinician and/or patient.

The screening requires a short time interval to provide results, typically on the order of twenty seconds. Once the clinician determines the severity of the disorder, the ratings for the aspects may be reviewed to determine a course of action. The field colors associated with the aspects enable a clinician to immediately identify problematic areas and determine a suitable psychological and/or biological approach. For example, a patient providing a low rating for concentration (e.g., a low rating in the blue field indicating high distractability) may be a suitable candidate for a stimulant. Similarly, a patient being treated with a stimulant and providing a low rating for organization (e.g., a low rating in the blue field) may be a suitable candidate for behavioral coaching. Thus, the color scheme enables the clinician to immediately identify problematic areas or the particular aspects receiving a low rating.

Tool 100 maybe further utilized to determine clinical response or patient response to treatment. In particular, the tool may be administered in substantially the same manner described above at particular periodic or other intervals or at a certain time interval after treatment. The various ratings should change in response to progression or regression. The total score and corresponding color change accordingly based on newly provided ratings. A decrease in total score and/or a color transition from green to red indicate patient regression, while an elevated total score and/or a color transition from red to green indicate patient progression. Thus, the combination of color and a concrete number assist the clinician and/or patient to measure progress. Further, the clinician may review the various aspect ratings to identify problematic areas and determine a suitable psychological and/or biological approach as described above. The tool basically provides a quick initial indication of the presence and/or severity of a mental disorder and enables the clinician to recommend further evaluation and/or treatment.

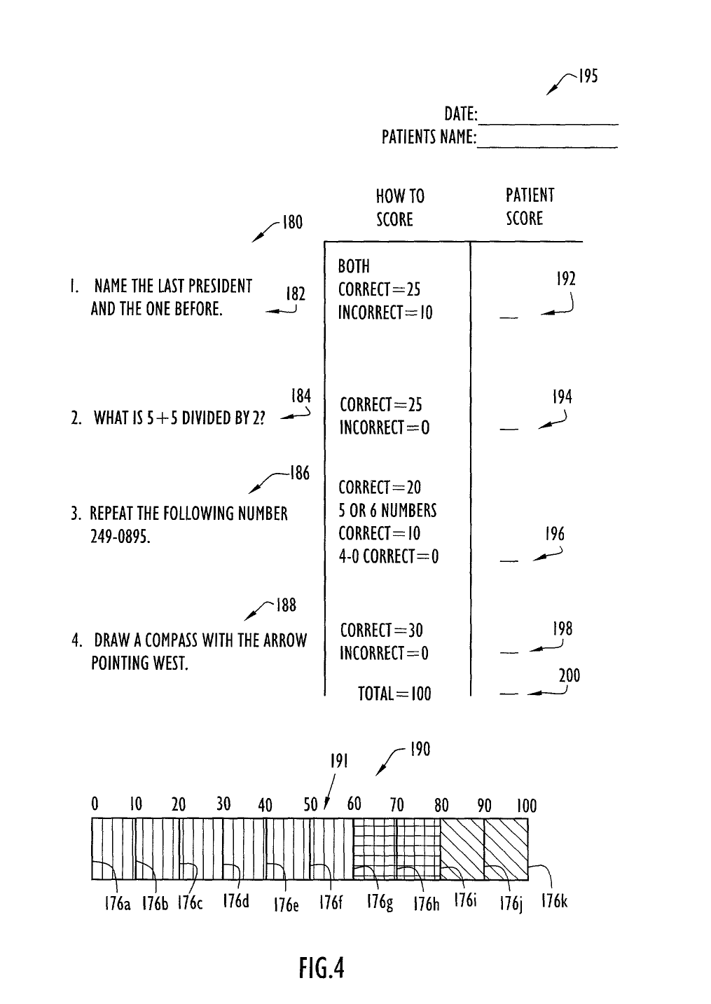

An exemplary tool to screen patients for the presence and/or severity of dementia is illustrated in FIG. 4. Specifically, tool 180 includes a plurality of inquiries 182, 184, 186, 188, a plurality of corresponding scoring fields 192, 194, 196, 198, a total score field 200, an information field 195 and a color score field 190. Field 195 is disposed toward the top of the tool and includes various text sections for receiving information concerning the patient and screening. This information may include the date and patient name. The information is typically placed in the fields by the clinician during screening of the patient.

Inquiry 182 is disposed in an upper tool portion and requests the clinician to ask the patient the names of the two preceding U.S. Presidents. The tool directs the clinician, via instructions adjacent the inquiry, to provide the patient with a score value of twenty-five for a correct answer and ten for an incorrect answer. The score is placed by the clinician in corresponding score field 192 disposed adjacent the instructions and below field 195. Inquiry 184 is disposed below inquiry 182 and requests the clinician to ask the patient to determine the value for the mathematical expression of five plus five divided by 2 (i.e., (5+5)/2). The tool directs the clinician, via instructions adjacent the inquiry, to provide the patient with a score value of twenty-five for a correct answer and ten for an incorrect answer. The score is placed by the clinician in corresponding score field 194 disposed adjacent the instructions and below score field 192.

Inquiry 186 is disposed below inquiry 184 and requests the clinician to require the patient to verbally repeat the numbers 249 0895. The tool directs the clinician, via instructions disposed adjacent the inquiry, to provide the patient with a score value of twenty for a correct answer, ten for repeating five or six digits of the seven digit number and zero for repeating less than five of the seven digits of the number. The score value is placed by the clinician in corresponding score field 198 disposed below score field 196.

Inquiry 188 is disposed below inquiry 186 and requests the clinician to require the patient to draw a compass with an arrow pointing west. The tool directs the clinician, via instructions disposed adjacent the inquiry, to provide the patient with a score value of thirty for a correct answer and zero for an incorrect answer. The score value is placed by the clinician in a corresponding score field 198 disposed adjacent the instructions and below score field 196. The clinician subsequently sums the score values for each inquiry to produce a total score value and places that value within total score field 200 disposed below score field 198.

Color field 190 is disposed below inquiry 188 and includes the colors of red, yellow and green. Field 190 basically serves as a color chart to indicate the presence and/or severity of the disorder as described below. The field includes a substantially rectangular bar 191 with a series of dividers 193a-k each associated with an incremental numeric value within the tool score range of zero to one-hundred and horizontally spaced at substantially equal distances from each other. By way of example only, the numeric values associated with the dividers are in increments often (e.g., 0, 10, 20, 30, 40, 50, 60, 70, 80, 90 and 100). Bar 191 includes different colors where the area between dividers 193a and 193g (representing the range from zero to sixty) is red, between dividers 193g and 193i (representing the range from sixty to eighty) is yellow and between dividers 193i and 193k (representing the range from eighty to one-hundred) is green. The total score is applied to field 190 to indicate the presence and/or severity of the disorder. In particular, the color of the bar area corresponding to the total score (e.g., the area including a divider associated with a value equal to the total score or including successive dividers with associated values forming a range within which the total score lies) provides the patient and/or clinician with a comprehendible and visible measure of the degree of cognitive functioning (or dementia) as described below. Basically, the red area or a total score between zero and sixty indicates the presence of dementia, the yellow area or a total score between sixty and eighty indicates possible dementia and the green area or a total score between eighty and one-hundred indicates the absence of dementia. Thus, the lower the total score, the greater the severity of the disorder.

The manner in which tool 180 is utilized to screen a patient for dementia is described. Basically, the manner of utilization of tool 180 is similar to the manner of utilization for the tools described above. Initially, a clinician enters information in field 195 of tool 180. This information may include the date and patient name. The clinician asks the patient each of the inquiries as described above. In response to each individual reply, the clinician determines and records a score value for that inquiry in the corresponding score field as described above. The clinician subsequently sums the score values for each inquiry to produce a total score and records that score in total score field 200. The total score is applied to color field 190 to determine the presence and/or severity of the disorder. In particular, the clinician identifies the bar area corresponding to the total score based on divider values. The color corresponding to the identified area provides a visual indication of the presence and/or severity of the disorder. Specifically, the red area indicates the presence of the disorder, while the green area indicates the absence of that disorder. The yellow area indicates possible presence of the disorder. By way of example only, field 190 includes a numeric range of zero to one-hundred. Total scores having values below sixty indicate dementia and the corresponding bar area including dividers associated with numerals in this range is red. Total scores having values between sixty and eighty indicate a possibility or suspicion of dementia and the corresponding bar area including dividers associated with numerals in this range is yellow. Total scores having values in excess of eighty indicate a lack of dementia and the corresponding bar area including dividers associated with numerals in this range is green. Thus, the particular color provides a visual indication of and immediately conveys the presence and/or severity of the disorder to the clinician and/or patient.

The screening requires a short time interval to provide an initial indication, typically on the order of one minute. The tool basically probes specific areas of cognitive thinking. These areas have been selected based upon research suggesting that these types of inquiries are reliable indicators of dementia. Therefore, probing these areas provides an adequate screening of a cognitive thinking disorder.

The tool may be further utilized to determine clinical response or patient response to treatment. In particular, the tool may be administered in substantially the same manner described above at periodic or other intervals or at a certain time interval after treatment. The various score values and, hence, the total score and corresponding color should change in response to progression or regression. A decrease in total score and/or a color transition from green or yellow towards red indicate patient regression, while an elevated total score and/or a color transition from red or yellow towards green indicate patient progression. Thus, the combination of color and a concrete number assists the clinician and/or patient to measure progress. The tool basically provides a quick initial indication of the presence and/or severity of a mental disorder and enables the clinician to recommend further evaluation and/or treatment.

It is to be understood that the tools described above may be implemented in several different manners. For example, the tools may be implemented as forms and administered manually to a patient by a clinician as described above. In this case, the clinician elicits responses from the patient, determines a total score and applies the total score to the color scale to determine the presence and/or severity of the disorder. Further, the tools may be implemented by a mechanical device including a board with the corresponding aspect, inquiry, inquiry score and/or total score fields and rating and/or color scales (FIGS. 1, 3 and 4), and mechanical levers or knobs (not shown) disposed proximate the rating scales and/or inquiry score fields to record or indicate ratings and/or inquiry scores. The clinician determines the total score and applies the total score to the color scale as described above to determine the presence and/or severity of the disorder. The mechanical device may alternatively include processing devices (e.g., microprocessor, computer, etc.) and displays to elicit responses from the patient, determine a total score and provide a visual indication of tool results. In addition, the tools may be implemented by a computer or other processing system (e.g., personal computer, Personal Digital Assistant, lap-top, microprocessor, etc.) programmed to elicit responses from patients, determine a total score and provide a visual indication (e.g., a color coded scale or bar) of tool results as described above. In this case, the displays are substantially similar to the tools illustrated in FIGS. 1, 3 and 4, while the patient and/or clinician may enter the responses.

The color coding of tool results within the present invention associates a particular color with a corresponding total score. This application of color enables the tool results to be comprehendible by an ordinary person. The color coding of the present invention may be applied to various medical tests. For example, a medical analysis (e.g., blood or urine sample analysis) provides qualitative information concerning a patient (e.g., blood counts, urine readings, etc.). The analysis results are commonly indicated in a report or display by monochromatic values with a corresponding range being provided for the clinician to interpret those values. However, in accordance with the present invention, the analysis values may be color coded to immediately indicate satisfactory or unsatisfactory levels. Byway of example only, abnormal blood counts or urine values may be indicated in red, while remaining satisfactory values are indicated in green. This enables a clinician to immediately identify problematic areas. The medical analysis results maybe color coded in any fashion to indicate any degree of severity of a particular area.

It will be appreciated that the embodiments described above and illustrated in the drawings represent only a few of the many ways of implementing a mental disorder screening tool and method of screening subjects for mental disorders.

The tool may be utilized to screen for any desired mental or other disorder and may include any quantity of aspects, questions or any other inquiries relating to a particular disorder. The tool may be administered by a clinician, physician, psychologist, psychiatrist or any other medical personnel. Alternatively, the tool may be administered by a patient or subject, and may be used by the patient as a self-test to screen for disorders outside of a medical office or facility (e.g., without the assistance of a medical professional). The tool may include any quantity of any types of questions or inquiries relating to a particular disorder in order to screen for that disorder. The manner of tool utilization described herein and illustrated in the flow chart may be modified in any manner that facilitates use of the tool to screen a subject for a disorder.

The tools (e.g., depression, attention deficit disorder, dementia, etc.) may include any quantity of any types of fields or sections. The fields (e.g., aspect, rating, score, inquiry, total score, information, etc.) may be of any shape, size or color, may be arranged in any fashion and be disposed at any suitable locations, and may include any desired information (e.g., field title, numerals, scales, charts, patient information (e.g., name, address, telephone number, etc.), date, time, previous scores, etc.). The tools may utilize any field titles to indicate the information for a corresponding field (e.g., aspect, inquiry, total or other score, etc.). The aspect fields may be color coded in any fashion to identify a particular aspect. The aspect ratings may be utilized in any manner to indicate treatment for the patient.

The rating scales of the tools may be of any shape or size and may include any desired numerals or ranges (e.g., zero to three, zero to five, zero to ten, one to ten, zero to one-hundred, one-hundred to one-thousand, etc.) partitioned in any manner (e.g., in any desired increments, such as one, ten, one-hundred, etc.). The rating scales of the tools may include any quantity of cells or dividers arranged in any fashion and associated with any values or range of values (e.g., numeric, alphanumeric, symbols, etc.). The associated values may be indicated within or external of the associated cell or divider in any manner.

The total score for the tools may be computed in any desired fashion and may be based on any quantity of responses or scores for tool questions. The response values may be weighted or combined (e.g., multiplied by any factor, accumulated, etc.) in any fashion to produce a total score. Alternatively, the sum of the response values maybe manipulated (e.g., multiplied by any factor to be consistent with color scale values, etc.) in any fashion to produce the total score. The total score may be in any desired range (e.g., numeric, alphanumeric, symbols, etc.) in accordance with the tool question ratings or inquiry scores. The color scale or bar of the tools may include any desired values or value ranges (e.g., zero to ten, zero to one-hundred, one-hundred to one-thousand, etc.) partitioned in any manner (e.g., in any desired increments, such as one, ten, one-hundred, etc.). The color scale may be of any shape or size and may include any quantity of cells or dividers arranged in any fashion and associated with any values or range of values (e.g., numeric, alphanumeric, symbols, etc.). The associated values may be indicated within or external of the associated cell or divider in any manner. The color scale maybe color coded in any fashion (e.g., different colors, various shades of the same color, etc.) and include any quantity of any colors associated with scale areas of any dimensions (e.g., colors may be associated with score ranges in any desired fashion) to indicate the presence and/or severity of a disorder. Colors may be assigned to the color scale in any fashion to indicate the presence, absence and/or severity of the disorder.

The information field maybe disposed at any location and indicate and/or receive any desired information (e.g., patient name, identification or Social Security Number, address and telephone number, date and/or time of screening, previous score, name of administrator, etc.).

The depression or other tools may include any quantity of aspects, questions or other inquiries relating to suicidal tendencies or other serious disorders. The tools may be administered individually or combined in any fashion to screen for various disorders. Alternatively, a tool may include any desired portions of the above-described tools or include any inquiries relating to various disorders to screen for any desired quantity of disorders.

The dementia tool may include any questions, inquiries or other problems to test the subject for dementia. The questions may relate to any generally known or common information (e.g., current or recent events, simple mathematical expressions, memory or number recall for numbers or strings having any quantity of digits or characters, etc.). The scoring values for the inquiries may be any desired values and may be assigned based on any degree of correctness for a response. The dementia tool color scale may alternatively be coded with red and green (i.e., without yellow), where the scale area associated with a total score between zero and sixty is red and represents the presence of dementia, the scale area associated with a total score between sixty and one-hundred is green and represents the absence of dementia, while total scores near sixty indicate the possibility of dementia.

The tools may be administered at any desired periodic or other time intervals to initially screen for a disorder or to indicate patient progress in response to treatment. The aspects of the tools may be rated by the patient based on any previous time interval (e.g., day, week, month, etc.). The tools may include any quantity of aspects or inquiries requiring response by the patient and any quantity of aspects or inquiries requiring response by the clinician. The tools may include only patient response type inquiries, only clinician response type inquiries or any combination of these types of inquiries.

The tools may be implemented manually via forms or a device including the inquiries and mechanical mechanisms to indicate rating and/or inquiry score values. The rating values, scores or other information may be indicated on the forms or device in any desired fashion (e.g., writing implement, pointer/indicator, etc.). Alternatively, the tools maybe implemented electronically via processing devices in the tool device described above, or via a computer system displaying screens illustrating the tool. The processing devices and computer system typically receive responses and determine the total score in order to visually display color coded results (e.g., in the form of the color scale where the total score is displayed or the color scale with the area corresponding to the total score indicated thereon). The processing devices and computer system may include conventional input devices and displays to receive and display any desired information. The software for the processing device and computer system could be developed by one of ordinary skill in the computer arts based on the description contained herein and the flow chart and figures illustrated in the drawings. In addition, the tools maybe accessible via a communications medium or network (e.g., LAN, WAN, Internet, etc.) for distributed use by clinicians or by patients as a self-testing mechanism for mental disorders.

The color coding of the present invention may be applied to any medical or other tests (e.g., medical lab work, cardiovascular/EKG report, psychological examinations, etc.) to visually display results. For example, reports or displays may provide test results with unsatisfactory levels displayed in a particular color (e.g., red) to readily indicate problematic areas. Satisfactory or marginal levels may be displayed in different respective colors (e.g., green and yellow) to immediately convey the adequacy level of the results. Thus, the report may be evaluated based on the colors of the results displayed therein.

It is to be understood that the terms “top”, “bottom”, “horizontal”, “vertical”, “front”, “rear”, “side” and the like are used herein merely to describe points of reference and do not limit the present invention to any particular configuration or orientation.

From the foregoing description, it will be appreciated that the invention makes available a novel mental disorder screening tool and method of screening subjects for mental disorders, wherein responses to inquiries relating to a particular disorder are utilized to produce a total score that is applied to a color coded chart or scale to visually indicate the presence and/or severity of that disorder.

Having described preferred embodiments of a new and improved mental disorder screening tool and method of screening subjects for mental disorders, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A method of screening a subject for a mental disorder comprising the steps of:
(a) presenting at least one inquiry to said subject relating to said disorder;
(b) receiving a response to each said inquiry;
(c) determining a score value for said screening based on each said response; and
(d) applying said screening score value to a color coded scale including colored areas associated with value ranges for said screening score value, wherein a color of a scale area associated with a value range encompassing said determined screening score value indicates the presence and/or severity of said disorder.

2. The method of claim 1, wherein said color of scale areas associated with value ranges of said screening score value indicating the presence of said disorder is red.

3. The method of claim 1, wherein said color of scale areas associated with value ranges of said screening score value indicating the absence of said disorder is green.

4. The method of claim 1, wherein said color of scale areas associated with value ranges of said screening score value indicating the possible presence of said disorder is yellow.

5. The method of claim 1, wherein said colored areas include various shades of a particular color, and wherein a color shade of a scale area associated with a value range encompassing said determined screening score value indicates the presence and/or severity of said disorder.

6. The method of claim 1, wherein step (a) further includes:
(a.1) presenting at least one inquiry to said subject relating to said disorder, wherein each inquiry requests said subject to rate at least one aspect of said disorder on a numerical scale.

7. The method of claim 6, wherein step (c) further includes:
(c.1) determining said screening score value by summing said aspect ratings and multiplying said sum by two.

8. The method of claim 6, wherein said disorder is depression, and step (a.1) further includes:
(a.1.1) presenting a plurality of inquiries to said subject relating to said disorder, wherein at least one inquiry requests said subject to rate an aspect of said disorder relating to suicidal tendencies on a numerical scale.

9. The method of claim 8, wherein said aspect relating to suicidal tendencies is the ability to enjoy life and said rating for that aspect indicates the presence and/or severity of suicidal tendencies.

10. The method of claim 6, wherein said disorder is depression, and step (a.1) further includes:
(a.1.1) presenting a plurality of inquiries to said subject relating to said disorder, wherein each inquiry requests said subject to rate an aspect of said disorder on a numerical scale, and wherein said aspects include mood, motivation, energy level, frustration tolerance and the ability to enjoy life.

11. The method of claim 6, wherein said disorder is attention deficit disorder, and step (a.1) further includes:
(a.1.1) presenting a plurality of inquiries to said subject relating to said disorder, wherein each inquiry requests said subject to rate an aspect of said disorder on a numerical scale, and wherein said aspects include concentration, frustration tolerance, ability to sit still, and ability to organize, start and complete tasks.

12. The method of claim 11, wherein step (a.1.1) further includes:
(a.1.1.1) presenting an inquiry to a screening administrator, wherein said inquiry requests said administrator to rate behavior of said subject during said screening on a numerical scale.

13. The method of claim 12, wherein step (c) further includes:
(c.1) determining said screening score value by summing said aspect and behavior ratings and multiplying said sum by two.

14. The method of claim 1, wherein said disorder is dementia, and step (c) further includes:
(c.1) assigning an inquiry score value for each response to said at least one inquiry; and
(c.2) determining said screening score value by summing each inquiry score value.

15. The method of claim 14, wherein step (a) further includes:
(a.1) presenting a plurality of inquiries to said subject relating to said disorder, wherein each inquiry requests said subject to determine a correct answer to a question, and wherein each said question relates to at least one of U.S. presidents, mathematical expressions, recall of a numeric value from memory and geographical direction.

16. A method of screening a subject for a mental disorder comprising the steps of:
(a) presenting at least one and a maximum of five inquiries to said subject relating to said disorder;
(b) receiving a response to each said inquiry;
(c) determining a score value for said screening based on each said response; and
(d) applying said screening score value to a screening scale including value ranges associated with the presence and/or severity of said disorder, wherein said value range encompassing said determined screening score value indicates the presence and/or severity of said disorder.

17. The method of claim 16, wherein said screening scale is color coded and includes colored areas associated with said value ranges, and step (d) further includes:
(d.1) applying said screening score value to said screening scale, wherein a color of a scale area associated with a value range encompassing said determined screening score value indicates the presence and/or severity of said disorder.

18. The method of claim 16, wherein step (a) further includes:
(a.1) presenting at least one and a maximum of five inquiries to said subject relating to said disorder, wherein each inquiry requests said subject to rate at least one aspect of said disorder on a numerical scale.

19. The method of claim 18, wherein step (c) further includes:
(c.1) determining said screening score value by summing said aspect ratings and multiplying said sum by two.

20. The method of claim 18, wherein said disorder is depression, and step (a.1) further includes:
(a.1.1) presenting said inquiries to said subject relating to said disorder, wherein at least one inquiry requests said subject to rate an aspect of said disorder relating to suicidal tendencies on a numerical scale.

21. The method of claim 20, wherein said aspect relating to suicidal tendencies is the ability to enjoy life and said rating for that aspect indicates the presence and/or severity of suicidal tendencies.

22. The method of claim 18, wherein said disorder is depression, and step (a. 1) further includes:
(a.1.1) presenting said inquiries to said subject relating to said disorder, wherein each inquiry requests said subject to rate an aspect of said disorder on a numerical scale, and wherein said aspects include mood, motivation, energy level, frustration tolerance and the ability to enjoy life.

23. The method of claim 18, wherein said disorder is attention deficit disorder, and step (a.1) further includes:
(a.1.1) presenting said inquiries to said subject relating to said disorder, wherein each inquiry requests said subject to rate an aspect of said disorder on a numerical scale, and wherein said aspects include concentration, frustration tolerance, ability to sit still, and ability to organize, start and complete tasks.

24. The method of claim 23, wherein step (a.1.1) further includes:
(a.1.1.1) presenting an inquiry to a screening administrator, wherein said inquiry requests said administrator to rate behavior of said subject during said screening on a numerical scale.

25. The method of claim 24, wherein step (c) further includes:
(c.1) determining said screening score value by summing said aspect and behavior ratings and multiplying said sum by two.

26. The method of claim 16, wherein said disorder is dementia, and step (c) further includes:
(c.1) assigning an inquiry score value for each response to said inquiries; and
(c.2) determining said screening score value by summing each inquiry score value.

27. The method of claim 26, wherein step (a) further includes:
(a.1) presenting said inquiries to said subject relating to said disorder, wherein each inquiry requests said subject to determine a correct answer to a question, and wherein each said question relates to at least one of U.S. presidents, mathematical expressions, recall of a numeric value from memory and geographical direction.

28. A tool for screening a subject for a mental disorder comprising:
presentation means for presenting at least one inquiry to said subject relating to said disorder;
receiving means for receiving and storing a response to each said inquiry;
value means for providing a score value for said screening based on each said response; and
indicator means for evaluating said determined screening score value, wherein said indicator means includes colored areas associated with value ranges for said screening score value, and wherein a color of an area associated with a value range encompassing said determined screening score value indicates the presence and/or severity of said disorder.

29. The tool of claim 28, wherein said presentation means includes aspect means for presenting at least one inquiry to said subject relating to said disorder, wherein each inquiry requests said subject to rate at least one aspect of said disorder on a numerical scale.

30. The tool of claim 29, wherein said disorder is depression, and said aspect means presents a plurality of inquiries to said subject relating to said disorder, wherein at least one inquiry requests said subject to rate an aspect of said disorder relating to suicidal tendencies on a numerical scale.

31. The tool of claim 29, wherein said disorder is depression, and said aspect means presents a plurality of inquiries to said subject relating to said disorder, wherein each inquiry requests said subject to rate an aspect of said disorder on a numerical scale, and wherein said aspects include mood, motivation, energy level, frustration tolerance and the ability to enjoy life.

32. The tool of claim 29, wherein said disorder is attention deficit disorder, and said aspect means presents a plurality of inquiries to said subject relating to said disorder, wherein each inquiry requests said subject to rate an aspect of said disorder on a numerical scale, and wherein said aspects include concentration, frustration tolerance, ability to sit still, and ability to organize, start and complete tasks.

33. The tool of claim 32, wherein said aspect means presents an inquiry to a screening administrator, wherein said inquiry requests said administrator to rate behavior of said subject during said screening on a numerical scale.

34. The tool of claim 28, wherein said disorder is dementia and said presentation means presents a plurality of inquiries to said subject relating to said disorder, wherein each inquiry requests said subject to determine a correct answer to a question, and wherein each said question relates to at least one of U.S. presidents, mathematical expressions, recall of a numeric value from memory and geographical direction.

35. A tool for screening a subject for a mental disorder comprising:
presentation means for presenting at least one and a maximum of five inquiries to said subject relating to said disorder;
receiving means for receiving and storing a response to each said inquiry;
value means for providing a score value for said screening based on each said response; and
indicator means for evaluating said screening score value, wherein said indicator means includes value ranges associated with the presence and/or severity of said disorder, and wherein said value range encompassing said determined screening score value indicates the presence and/or severity of said disorder.

36. The tool of claim 35, wherein said indicator means is color coded and includes colored areas associated with said value ranges, and wherein a color of a scale area associated with a value range encompassing said determined screening score value indicates the presence and/or severity of said disorder.

37. The tool of claim 35, wherein said presentation means includes aspect means for presenting said inquiries to said subject relating to said disorder, wherein each inquiry requests said subject to rate at least one aspect of said disorder on a numerical scale.

38. The tool of claim 37, wherein said disorder is depression, and said aspect means presents said inquiries to said subject relating to said disorder, wherein at least one inquiry requests said subject to rate an aspect of said disorder relating to suicidal tendencies on a numerical scale.

39. The tool of claim 37, wherein said disorder is depression, and said aspect means presents said inquiries to said subject relating to said disorder, wherein each inquiry requests said subject to rate an aspect of said disorder on a numerical scale, and wherein said aspects include mood, motivation, energy level, frustration tolerance and the ability to enjoy life.

40. The tool of claim 37, wherein said disorder is attention deficit disorder, and said aspect means presents said inquiries to said subject relating to said disorder, wherein each inquiry requests said subject to rate an aspect of said disorder on a numerical scale, and wherein said aspects include concentration, frustration tolerance, ability to sit still, and ability to organize, start and complete tasks.

41. The tool of claim 37, wherein said aspect means presents an inquiry to a screening administrator, wherein said inquiry requests said administrator to rate behavior of said subject during said screening on a numerical scale.

42. The tool of claim 35, wherein said disorder is dementia and said presentation means presents said inquiries to said subject relating to said disorder, wherein each inquiry requests said subject to determine a correct answer to a question, and wherein each said question relates to at least one of U.S. presidents, mathematical expressions, recall of a numeric value from memory and geographical direction.

43. A method of indicating medical examination results of a subject to enable rapid evaluation of said results, said method comprising the steps of:
(a) assigning particular colors to adequacy levels for said medical examination results; and
(b) color coding each result of said medical examination in accordance with said color assignment and said adequacy level of that result.

44. The method of claim 43, wherein step (a) further includes:
(a.1) assigning a first color to indicate a satisfactory level for said medical examination results; and
(a.2) assigning a second color different from said first color to indicate an unsatisfactory level for said examination results; and
step (b) further includes:
(b.1) coloring each result of said medical examination having a satisfactory level with said first color; and
(b.2) coloring each result of said medical examination having an unsatisfactory level with said second color.

45. The method of claim 44, wherein step (a) further includes:
(a.3) assigning a third color different from said first and second colors to indicate a marginal level for said examination results; and
step (b) further includes:
(b.3) coloring each result of said medical examination having a marginal level with said third color.

46. The method of claim 1 further including:
(e) screening said subject subsequent treatment for said mental disorder to determine subject progression in response to said treatment.

47. The method of claim 16 further including:
(e) screening said subject subsequent treatment for said mental disorder to determine subject progression in response to said treatment.
